(19) United States
(12) Patent Application Publication
(10) Pub. No.: US 2017/0279896 A1
(43) Pub. Date: Sep. 28, 2017

(54) SYSTEM AND METHOD FOR PROVIDING INTERACTIVE CONTENT TO A USER

(71) Applicant: Bally Gaming, Inc., Las Vegas, NV (US)

(72) Inventors: Bryan M. KELLY, Alamo, CA (US); Theodore KEENAN, Castro Valley, CA (US); Dennis LOCKARD, Tracy, CA (US); Rukmangada RUPANAGUDI, Pleasanton, CA (US)

(21) Appl. No.: 15/467,015

(22) Filed: Mar. 23, 2017

Related U.S. Application Data
(60) Provisional application No. 62/313,294, filed on Mar. 25, 2016.

(51) Int. Cl. H04L 29/08; H04W 4/00

(52) U.S. Cl. CPC H04L 67/14; H04L 67/10; H04L 67/26; H04W 4/008; H04W 88/02

(57) ABSTRACT

Systems and methods are set forth which provide seamless connectivity between an enterprise and a user's mobile device and a fixed terminal such as a gaming terminal. The connectivity can follow the user through several different communication channels and can enable different content, including interactive content, to be provided based upon the communication channel currently invoked which can be attributed to the user's location as either within a venue and at a terminal or roaming about remote from the terminal and venue. In various embodiments the system may be open to outside content providers to provide content to a user of the system. The systems and methods also support the use of an electronic wallet account for funding activities.

### CROSS-REFERENCE TO RELATED APPLICATION

This application is a non-provisional application claiming the benefit of U.S. Provisional Patent Application Ser. No. 62/313,294 filed Mar. 25, 2016.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The field of the invention relates to systems and methods for an enterprise to provide interactive content to a user in an uninterrupted, seamless fashion at a user terminal or at the user's mobile device. More particularly where the enterprise is a gaming enterprise to provide, in a seamless manner, interactive content in the nature of promotions, games, advertising and information such that the player has uninterrupted access to the content at their mobile device within and outside of the enterprise through alternative communication channels, where content can be player-customized, where the communication channel utilized by the mobile device provides location information, where a player's activities and movements can be tracked and where content can be customized based upon the location of the mobile device and where player benefits and eligibilities can persist through the various location based content.

### BACKGROUND

In the gaming industry it is known to provide a player loyalty system. In such a system the player is issued a player identification card and a player account is established at a back-end system of one or more servers and databases. The gaming devices in the gaming enterprise venue such as slot machines, live gaming tables, point-of-sale terminals, kiosks and other commercial interaction points are networked through a hard-wired, terrestrial network to the back-end system. When a player approaches for example a gaming device, they insert their player tracking card into a card reader at the gaming device which reads the encoded card to, through the terrestrial network, interface with the player's account. The gaming device may include a system interface including a small video display to display system and account related information to the player. Alternatively the system interface may be presented as an interactive window at the gaming device game video display as described in Kelly et al, U.S. Pat. No. 8,241,123 issued Aug. 4, 2012 and titled “VIDEO SWITCHER AND TOUCH ROUTER METHOD FOR A GAMING MACHINE” the disclosure of which is incorporated by reference. As the player wagers at the gaming device comp points accrue to the player's account. These points can be redeemed for cash, goods and services at the enterprise.

It has also been known to support system provided games through the interactive system display at the gaming device. For example in Lowell et al, U.S. Pub 2014/0057702 filed Apr. 10, 2013 and titled “SYSTEM AND METHOD FOR PROVIDING A MYSTERY PRIZE”, the disclosure of which is incorporated by reference, there is disclosed a system managed mystery game of Bingo, Keno or a sporting event where players earn system game entries or may buy, or redeem vouchers for, additional entries using the system interface.

It is believed that in the United States alone there are currently about 200 millions of mobile, smart phone users. This number is only expected to increase. These devices are capable of communication through several communication channels: a channel within the ultra-high frequency band assigned for mobile cellular communications such as 2G, 3GPP and 4G standards and one or more short range channels such as Bluetooth® or near field communications (“NFC”). The advantage of a mobile device such as a smart phone is that the user has the device with them at all times and locations and can thereby remain “connected” to a content source no matter where they move to.

It has been known for a casino enterprise to leverage their player loyalty program by providing remote home PC and mobile device access to services such as, in Nevada, race and sports book services as well as access to player account information for an enrolled player. It has also been known to provide common content across several communication channels. For example, in Link et al, U.S. Pat. No. 8,926,425 issued Jan. 6, 2015 and titled “SYSTEM AND METHOD FOR PROVIDING LOYALTY-BASED VIRTUAL OBJECTS ACROSS VARIOUS MEDIA INCLUDING GAMING DEVICES”, the disclosure of which is incorporated by reference, there is disclosed a system to promote player loyalty to a casino enterprise by providing the player with a virtual pet for which the player can earn/acquire attributes and accessories. The virtual pet and its current condition/accessories can be displayed at the gaming device system interface display as well as, when the layer is remote from the gaming device, at a player's remote mobile device, computer or laptop.

A drawback to the prior systems is that the player's interface with the system and its features and content is not seamless to the player. A player may access system related features/content at a gaming device system interface but if the player leaves the gaming device those features and the content may no longer be presented/available until the player renews a connection to the service elsewhere, such as at the home PC or their mobile device. If the features are available to the player on their mobile device the player must go through a separate log-in to access the features through the mobile channel. It would be advantageous if a player at a gaming terminal could bind their mobile device to the network to concurrently view the system provided features/content at the gaming device system interface display and their mobile device, where the player can opt to view the content at either the system interface display or their mobile device and if the player leaves the gaming device the features/content are seamlessly provided via a short range or mobile cellular communication channel. Thus, if the player were playing a system supported game at the gaming device and left the device, play could seamlessly continue on their mobile device.

In regards to the foregoing it would be advantageous to provide the player with a virtual wallet that can be accessed through a communication channel to support gaming, where legal, or to purchase goods/services. In this regard it would beneficial to provide a system and method where a player may transfer funds from their virtual wallet to others such as a wife or friend.

It would be advantageous to track a player's activities through all communication channels for purposes of business intelligence. Based upon the player's activities, purchases and locations advertising, games and marketing may be seamlessly provided to the player. This marketing may include games for free or trial play, discounts, entries in raffles or the like.

Other industries have customer loyalty systems such as airlines, department stores and grocery stores to name a few. They too have the disadvantage of not providing a seamless content presence to the customer across different communication channels.

### SUMMARY OF THE INVENTION

There is, therefore, set forth according to the present invention systems and methods which provide seamless connectivity between an enterprise and a user's mobile device and a fixed terminal such as a gaming device. The connectivity can follow the user through several different communication channels and can enable different content, including interactive content, to be provided based upon the communication channel currently invoked which can be attributed to the user's location as either within a venue and at a terminal or roaming about remote from the terminal and venue. In various embodiments the system may be open to outside content providers to provide content to a user of the system.

In an embodiment an improved system for providing for seamless user interactive content to a user's mobile device and at a user terminal is provided. The system has one or more data servers and data repositories to package and transmit content via several communication channels to users. The content may be configured based upon the user's terminal/device display characteristics. The content may be non-interactive content such as advertising, promotions or notifications or may be interactive content such as user-centric interactive content including, but not limited to, user account information and transaction related information, games, surveys, promotions or the like. The one or more data servers and data repositories include access to a wireless mobile telephone bi-directional first communication channel for wire-less telephonic communication with the user mobile device. This first channel may be a wire-less mobile cellular G4 network or equivalent and is accessed to provide connectivity with the user's mobile device when the user is not is a location in/near a venue or terminal therein where connectivity can be handed over to a wire-less short-range, bi-directional communication channel. The user's mobile device has a video display and a user input interface which may be a touch display or button panel.

The terminals include a terminal video display and are in bi-directional network communication with the one or more servers such as through a cabled or secure wireless network. The improved system includes a software application to configure the user's mobile device for establishing the wire-less first communication channel link with the one or more servers to receive and display the interactive content at the mobile device display and to transmit user inputs from the user interface to the one or more servers. For example, where a player enrolls in a casino enterprise loyalty system they may be provided with access to download the software application to their mobile device. The improved system also includes one or more a short range communication beacon-transceivers located for example within the casino venue and associated with the gaming device terminals.

The software application is also adapted for configuring the user's mobile device to establish a bi-directional short-range second channel communication link between the user's mobile device and the one or more servers when the user's mobile device is within a short range of a beacon-transceiver. Where the locations of the beacon-transmitters are known establishment of the second channel communication with the user's mobile device defines a geo-location for the user's device. For example, where the terminals are gaming devices and each has a beacon-transceiver, the geo-location of the user and nearby gaming terminals can be defined. Where a user or player must identify themselves at a terminal the location of the user/player also becomes known. This local “binding” of the user's mobile device to the network can be by the user acquiring an image of a bar code or QR code on or displayed at the gaming terminal or entering their cell phone number on their mobile device. This identifies the user and links their mobile device to the system.

The one or more servers and data repositories are configurable to provide content to the user such interactive content. By interactive content what is meant is that the user or player responds to or controls an aspect of the content such as by accepting an offer, playing an interactive game or providing other input to interact with the content.

The one or more servers and user's mobile device are configured by the software application to provision the content to a user's mobile device through the first communication channel where the mobile device is disconnected with the second communication channel. For example, after the a casino player has bound their mobile device to the system he/she may view their account information or play interactive games on their mobile device at locations remote from the casino or in areas not serviced by beacon-transmitters. When the player enters the casino and identifies, i.e. binds, with a gaming device and is within the zone served by the second communication channel, one or more servers and/or user's mobile device are configured by the application to hand over delivery of the system content to be provisioned through the second communication channel. Where the player has identified with a gaming device the content may be concurrently provisioned to the player through the terminal display. If the player leaves the gaming device and moves from the zone serviced by the second communication channel, provisioning of the content is handed back over to the first communication channel.

In an embodiment the content provided through either of the first and second channels may the same. In another embodiment some or all of the content provided through the first communication channel may be different than content provided through the second communication channel. For example short term promotions or community activities may be available through the second communication channel since it is known the player is within the casino venue.

In an embodiment where the content is different based upon the communication channel, attributes and benefits may be carried over by a user between the different content. For example, a player may be offered a play-for-fun (P4F) game via the first communication channel to play on their mobile device since the player is likely at a location where wager-based gaming is not permitted. Playing the P4F game the player may earn a feature which is stored at one or more of the servers of mobile device which can be redeemed or unlocked when the player enters the casino and establishes the second communication channel or identifies with a gaming device.

In an embodiment the user's activities one either channel as well as detected locations may be analyzed with business intelligence software to configure player-centric content.

In another embodiment the user's account information includes a virtual wallet which the user may seamlessly access through the system to buy goods or services, transfer funds to others or monitor their account.

In an embodiment the system may be configured to include a user configurable software offer engine by which the enterprise host may configure promotions and offers, the criteria for earning the promotion and how the promotion may be redeemed. Redemption may include the play of a game on the user's mobile device.

In an embodiment where the player does not identify with the terminal such as a gaming machine and is otherwise not identified to the system, a “doe” account can be established at the one or more servers and data repositories and can be tied to the user using the user's mobile telephone number and/or a personal identification number (PIN).

Also set forth is a method for providing seamless user interactive content to a user's mobile device in an environment including a user terminal in communication with a host system of one or more data servers and data repositories through a primary communication network, the terminal including a system video display. The method includes enabling communication between a short range wireless beacon-transmitter associated with the terminal and the host system through the primary communication network. Where multiple terminals are provided in the primary network, each may have an associated beacon-transmitter and the geo-locations of the beacon-transmitter may be known.

A software application is provided to configure the user's mobile device for establishing a wireless, mobile cellular, first communication channel for bi-directional communication between the user's mobile device and the host system and a wireless, bi-directional, short-range, second communication channel with the wireless beacon-transceiver and the host system via the primary communication network. When the user is determined to be at the terminal the method includes enabling concurrent delivery of interactive content from the host system to the terminal display and user's mobile device through the second communication channel and when the user is not at the terminal handing over the delivery of the interactive content connection to the first communication channel.

Other features and numerous advantages of the various embodiments will become apparent from the following detailed description when viewed in conjunction with the corresponding drawings.

### BRIEF DESCRIPTION OF THE DRAWINGS

FIG. 1 illustrates a user terminal shown as a gaming terminal;

FIGS. 2A-B illustrate an example of a gaming terminal operational platform and components for a gaming terminal of the type of the present invention;

FIG. 3 is a block diagram of the logical components of a gaming kernel for a gaming terminal.

FIGS. 4A and 4B is a schematic of an example of a host casino enterprise server and data repository network incorporating gaming terminals;

FIG. 5 is a diagram showing an example of an architecture for providing seamless communication of interactive content to a player and for supporting business analytics related to the player's interactions;

FIG. 6 is a logic diagram illustrating an embodiment of the operation of a software application to seamlessly switch provisioning channels to a player's mobile device based upon the player's movements;

FIGS. 7A-C illustrate views to a player of interactive system derived content to a display window defined at a gaming terminal display;

FIGS. 8A-C illustrate examples of content provisioned to a user's mobile device display;

FIG. 9 illustrates the seamless delivery of system derived interactive content to a gaming terminal and to a player's mobile device; first and second communication channels in a gaming enterprise environment;

FIG. 10 is another illustration of the system for delivery of content via multiple communication channels to a user's mobile device as well as to the gaming terminal and signage; and

FIG. 11 is a logic diagram for a mobile device software application according to various embodiments of the present invention.

### DESCRIPTION

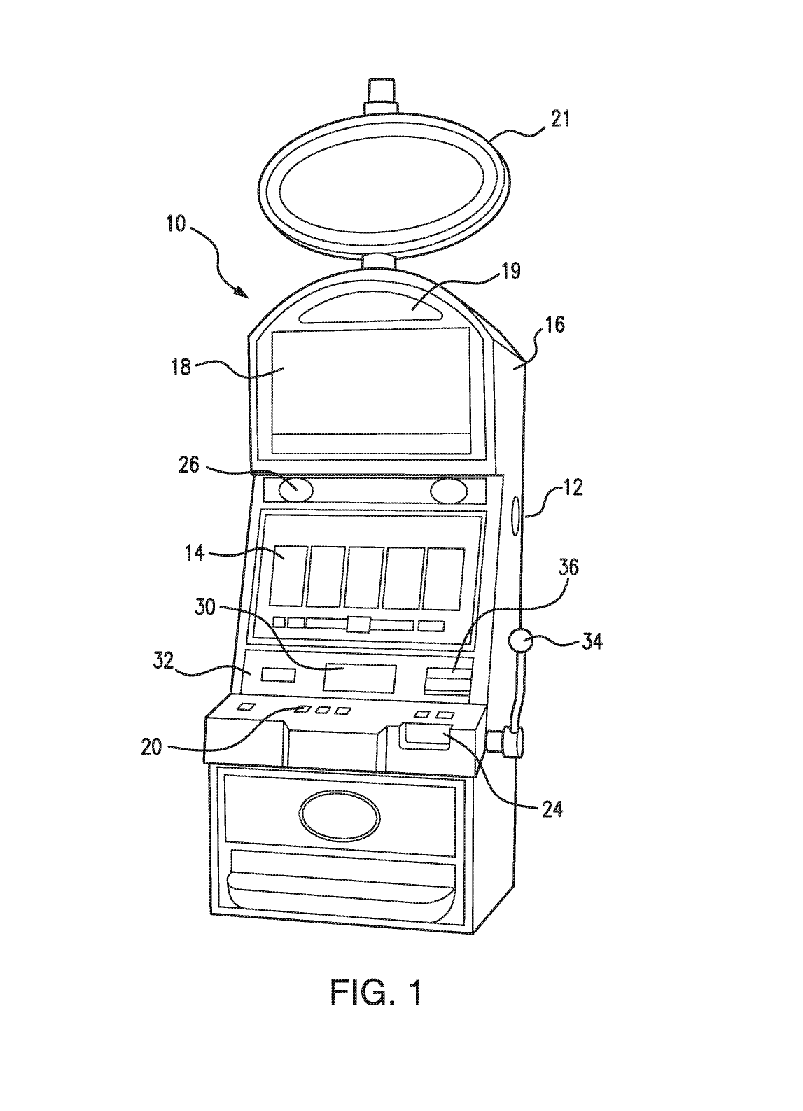

Referring now to the drawings, wherein like reference numbers denote like or corresponding elements throughout the drawings, and more particularly referring to FIG. 1, a gaming terminal 10 according to one or more embodiments of the present invention is shown. While an embodiment of the present invention will be described with reference to a gaming environment it should be understood that the invention has other applications such as where the terminals are point-of-sale terminals or kiosks in a mercantile environment. The gaming terminal 10 includes cabinet 12 providing an enclosure for the several components of the gaming terminal 10 and associated equipment. A primary game display 14 is mounted to the cabinet 12. The primary game display 14 may be a video display such as an LCD, plasma, OLED or other electronic display or it may be an electro-mechanical display such as electro-mechanical stepper reels as are known in the art. The primary game display 14 may also be embodied as a combination of two or more electronic or mechanical displays disposed in an adjacent overlapping or overlying arrangement. The primary game display 14 may be mounted to one or more of a door for the cabinet 12 or the cabinet chassis itself. The primary game display 14 is located to display game content (and if desired other content) to the player. For example, the game content may be game outcomes presented by a plurality of video or electro-mechanical reels displaying symbols the combinations of which define winning or losing outcomes. Where the primary game display 14 is a video display, features such as bonus games may also be presented. The foregoing description should not be deemed as limiting the content (graphics, video or text) which can be displayed at the primary game display 14. The cabinet 12 may comprise a slant-top, bar-top, or table-top style cabinet as is known in the art.

The gaming terminal 10 also includes in one or more embodiments a top box 16 which may support a printed back-lit glass (not shown) as is known in the art depicting the rules, award schedule, attract graphics or it may support a secondary display 18 which may be of one of the types described above with reference to the primary game display 14. The top box 16 may also support a backlit glass with graphics defining a marquee 19 and a topper 21 including additional graphics.

To enable a player to provide input to the controller for the gaming terminal 10 a plurality of buttons 20 may be provided on a button deck for the gaming terminal 10. Additionally and alternatively one or both of the primary and secondary game displays 14, 18 may include touch screen input devices as are known in the art. Buttons, selections or inputs are displayed at the primary and secondary displays 14, 18 and the player touching those icons or designated areas provides the required or desired input to configure and play the gaming terminal 10.

Other peripherals or associated equipment for the gaming terminal 10 include a bill/voucher acceptor 24 which reads and validates currency and vouchers for the player to establish credits for gaming on the gaming terminal 10 and one or more speakers 26 to provide audio to the player in association with the game play. To provide for communication between the gaming terminal 10 and a host casino system, a player tracking module (PTM) 28 is mounted on the cabinet 12. PTM 28 has a PTM display 30 to display system related information to the player such as interactive system derived content. The PTM display 30 may be a small LCD, plasma or OLED display with touch screen functionality. A card reader 32 is provided to read a machine readable component on a player loyalty card issued to the player to identify the player to the casino system as in known in the art. A ticket printer 36 may be provided as well on the PTM 28 or elsewhere on the gaming terminal 10 to provide printed value ticket vouchers to players as is known in the art.

Some functionality of the PTM 28 may be provided by a video switcher and touch router device as is described in Kelly et al, U.S. Pub. App. 2009/0149253 entitled “Video Switcher and Touch Router Method for a Gaming Machine” filed Jan. 8, 2009 and incorporated by reference. According to this disclosure system derived and externally based content, including interactive content, may be displayed at one or more locations or “windows” defined at one or more of the primary or secondary displays 14, 18 dispensing with the need for the PTM display 30.

While the player may use the buttons 20 to prompt play of the game (or the touch screen input), alternatively the player may use a handle 34 to prompt an input as is known in the art.

Cabinet 12 housing may be a self-standing unit that is generally rectangular in shape and may be manufactured with reinforced steel or other rigid materials which are resistant to tampering and vandalism. Any shaped cabinet may be implemented with any embodiment of gaming terminal 10 so long as it provides access to a player for playing a game. For example, cabinet 12 may comprise a slant-top, bar-top, or table-top style cabinet, including a Bally Cinevision™ or CineReels™ cabinet. The gaming terminal 10 may include a controller and memory disposed within the cabinet 12 or may have thin client capability such as that some of the computing capability is maintained at a remote server.

The plurality of player-activated buttons 22 may be used for various functions such as, but not limited to, selecting a wager denomination, selecting a game to be played, selecting a wager amount per game, initiating a game, or cashing out money from gaming terminal 10. Buttons 22 may be operable as input mechanisms and may include mechanical buttons, electromechanical buttons or touch screen buttons. In one or more embodiments, buttons 22 may be replaced with various other input mechanisms known in the art such as, but not limited to, touch screens, touch pad, track ball, mouse, switches, toggle switches, or other input means used to accept player input. For example, one input means is as disclosed in U.S. Pub. App. 2011/0111853, entitled “Universal Button Module,” filed on Jan. 14, 2011 and/or U.S. Pub. App. 2010/0113140 entitled “Gesture Enhanced Input Device” filed Nov. 16, 2009 which are hereby incorporated by reference. Player input may also be by providing touch screen functionality at the primary display 14 and/or secondary display 18.

The primary display 14 may present a game of chance wherein a player receives one or more outcomes from a set of potential outcomes. For example, one such game of chance is a video slot machine game. In other aspects of the invention, gaming terminal 10 may present a video or mechanical reel slot machine, a video keno game, a lottery game, a bingo game, a Class II bingo game, a roulette game, a craps game, a blackjack game, a mechanical or video representation of a wheel game or the like.

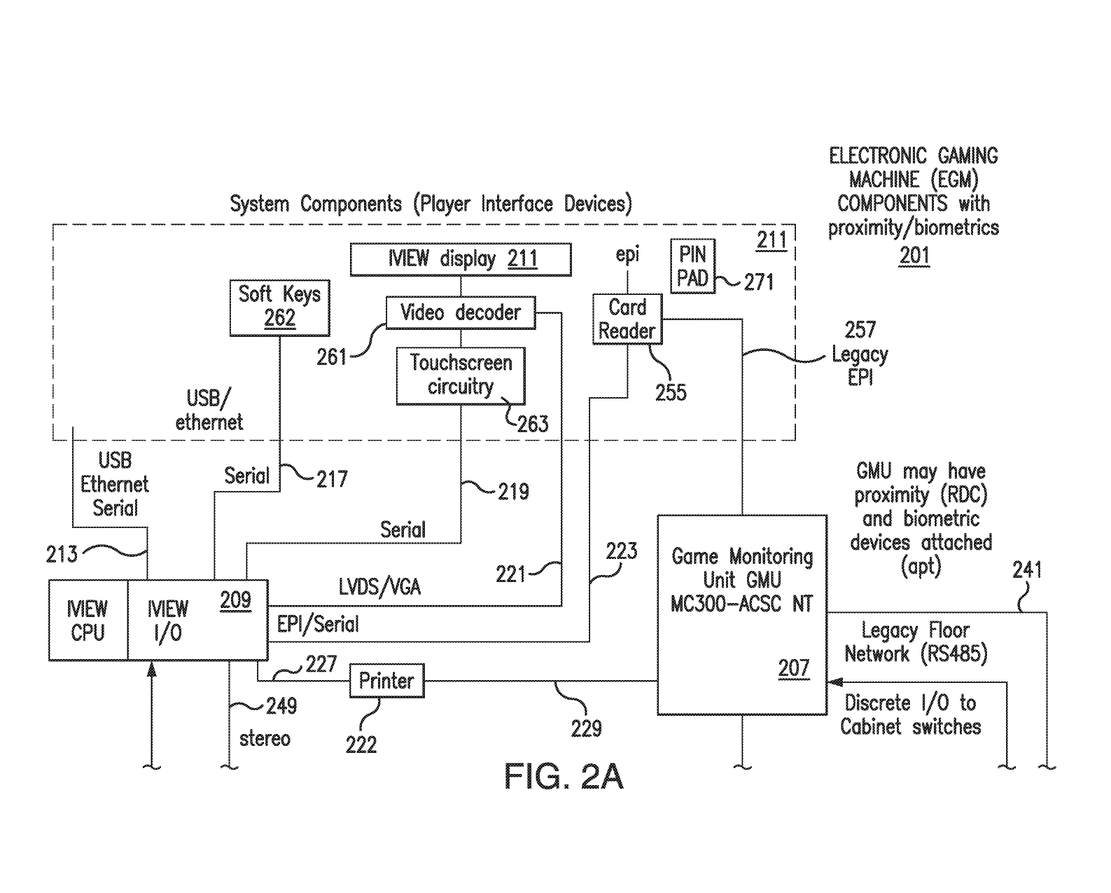

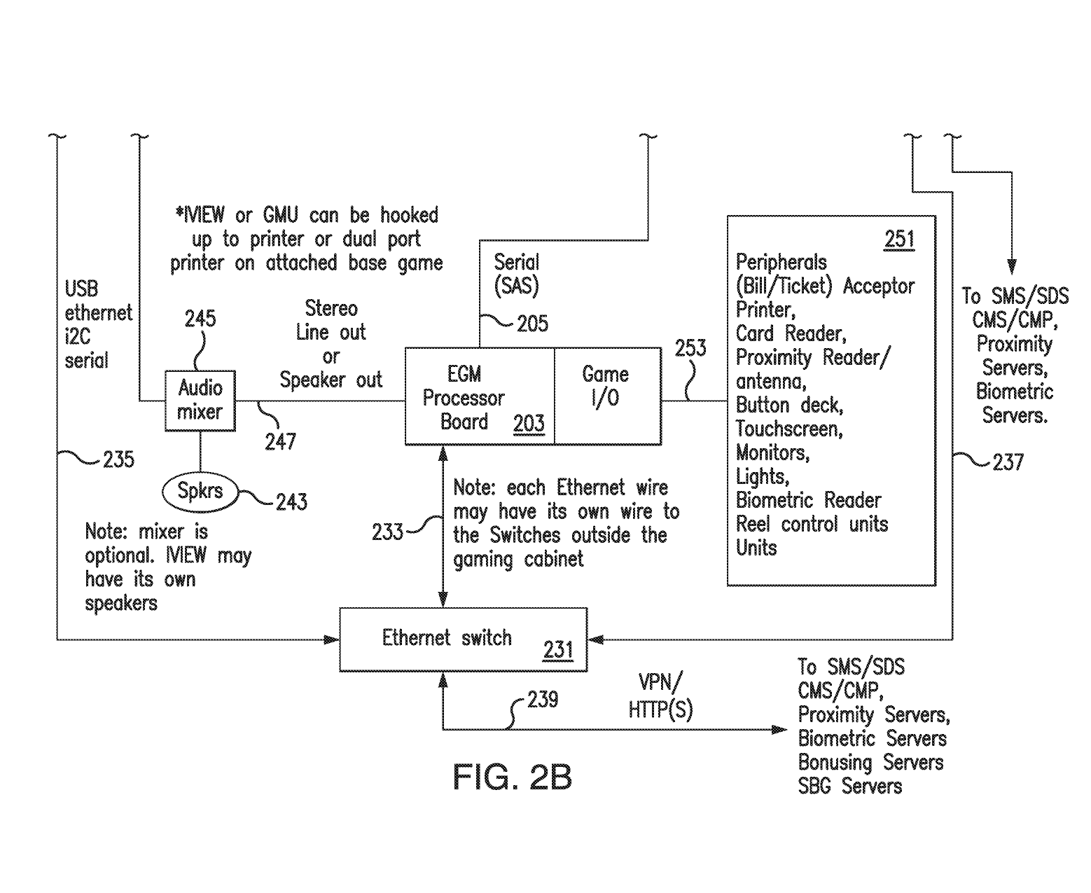

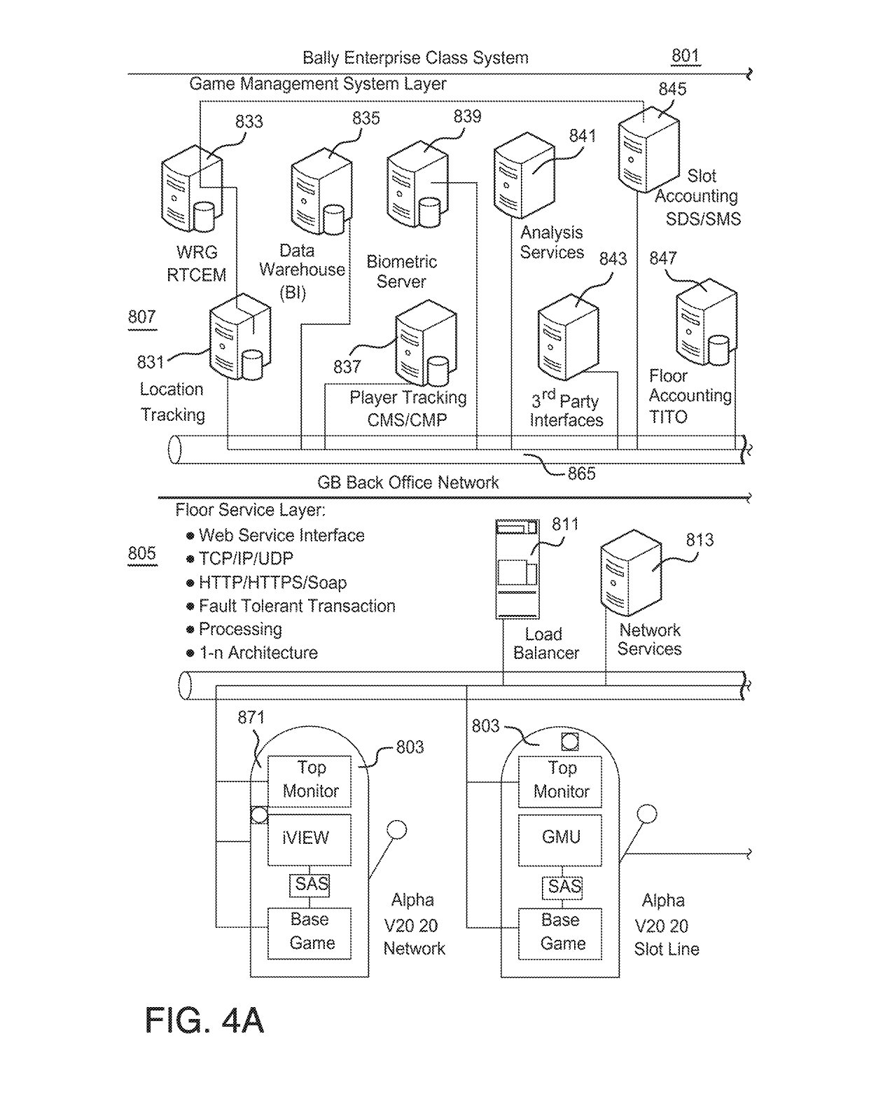

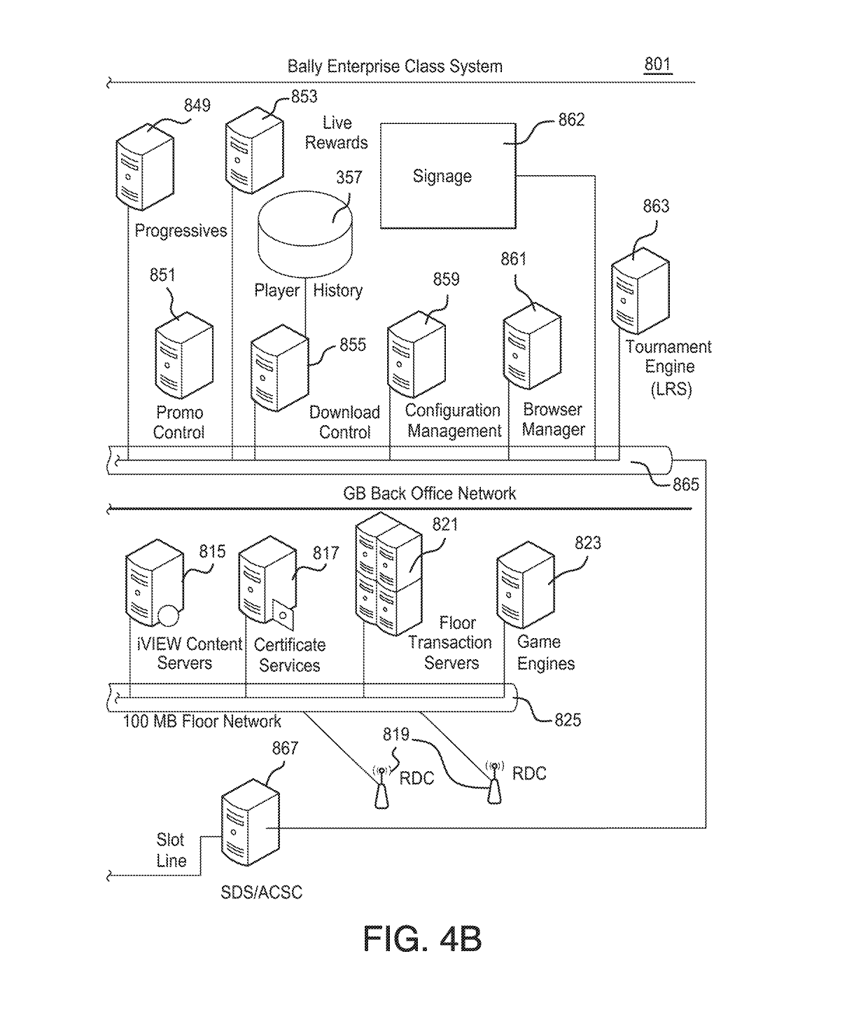

Referring to FIGS. 2A, B, the gaming terminal 100 hardware 200 for the controller(s) is shown in accordance with one or more embodiments. The hardware 200 includes base game integrated circuit Processor Board 202 (EGM Processor Board) connected through serial bus line 204 to game monitoring unit (GMU) 206 (such as a Bally MC300 or ACSC NT), and player interface integrated circuit board (PIB) 208 connected to the player tracking module (PTM) 28 over bus lines 210, 212, 214, 216, 218. The PTM 28 provides for communication between one or more gaming terminals 10 and the casino system such as the type as hereinafter described. Inasmuch as gaming terminals 10 may be manufactured by different entities, mounting like PTMs 28 at each gaming terminal 10 provides for communication to the system in one or more common message protocols. The video switcher and touch router device as is described in U.S. Pub. App. 2009/0149253 entitled “Video Switcher and Touch Router Method for a Gaming Machine” referenced above also enables the system provider to provide system content at one or more of the primary or secondary displays 14, 18. Gaming voucher ticket printer 36 (for printing player cash out tickets) is connected to PIB 208 and GMU 206 over bus lines 222, 224. EGM Processor Board 202, PIB 208, and GMU 206 connect to Ethernet switch 226 over bus lines 228, 230, 232. Ethernet switch 226 connects to a slot management system and a casino management system (SMS, SDS, CMS and CMP) (FIGS. 4A, B) network over bus line 234. Ethernet switch 226 may also connect to a server based gaming server or a downloadable gaming server. GMU 206 also may connect to the network over bus line 236. Speakers 26 to produce sounds related to the game or according to the present invention connect through audio mixer 238 and bus lines 240, 242 to EGM Processor Board 202 and PIB 208.

Peripherals 244 connect through bus 246 to EGM Processor Board 202. The peripherals 244 include, but are not limited to the following and may include individual processing capability: bill/voucher acceptor 24 to validate and accept currency and ticket vouchers, the player interfaces such a buttons 20, primary and secondary displays 14, 18 and any secondary or tertiary displays (with/without) touch screen functionality, monitors and lights. The peripherals 244 may include the displays as hereinafter described with reference to the various embodiments of the present invention as herein described or their equivalents. For example, the bill/voucher acceptor 24 is typically connected to the game input-output board of the EGM Processor Board 202 (which is, in turn, connected to a conventional central processing unit (“CPU”) board), such as an Intel Pentium® microprocessor mounted on a gaming motherboard. The I/O board may be connected to CPU processor board by a serial connection such as RS-232 or USB or may be attached to the processor by a bus such as, but not limited to, an ISA bus. The gaming motherboard may be mounted with other conventional components, such as are found on conventional personal computer motherboards, and loaded with a game program which may include a gaming machine operating system (OS), such as a Bally Alpha OS. EGM Processor Board 202 executes a game program that causes the gaming terminal 10 to display and play a game. The various components and included devices may be installed with conventionally and/or commercially available components, devices, and circuitry into a conventional and/or commercially available gaming terminal cabinet 12.

When a player has inserted a form of currency such as, for example and without limitation, paper currency, coins or tokens, cashless tickets or vouchers, electronic funds transfers or the like into the currency acceptor, a signal is sent by way of bus 246 to the I/O board and to EGM Processor Board 202 which, in turn, assigns an appropriate number of credits for play in accordance with the game program. The player may further control the operation of the gaming machine by way of other peripherals 244, for example, to select the amount to wager via the buttons 20. The game starts in response to the player operating a start mechanism such as the handle 34, button 20 such as a SPIN/RESET button or a touch screen icon. The game program includes a random number generator to provide a display of randomly selected indicia on one or more displays such as the primary display 14 as shown in FIG. 1. In some embodiments, the random generator may be physically separate from gaming terminal 10; for example, it may be part of a central determination host system which provides random game outcomes to the game program. Finally, EGM Processor Board 202 under control of the game program and OS compares the outcome to an award schedule. The set of possible game outcomes may include a subset of outcomes related to the triggering and play of a feature or bonus game. In the event the displayed outcome is a member of this subset, EGM Processor Board 202, under control of the game program and by way of I/O Processor Board 202, may cause feature game play to be presented on the primary display 14 and/or any secondary display(s) 18.

Predetermined payout amounts for certain outcomes, including feature game outcomes, are stored as part of the game program. Such payout amounts are, in response to instructions from Processor Board 202, provided to the player in the form of coins, credits or currency via I/O board and a pay mechanism, which may be one or more of a credit meter, a coin hopper, a voucher printer, an electronic funds transfer protocol or any other payout means known or developed in the art.

In various embodiments, the game program is stored in a memory device (not shown) connected to or mounted on the gaming motherboard. By way of example, but not by limitation, such memory devices include external memory devices, hard drives, CD-ROMs, DVDs, and flash memory cards. In an alternative embodiment, the game programs are stored in a remote storage device. In an embodiment, the remote storage device is housed in a remote server such as a downloadable gaming server. The gaming machine may access the remote storage device via a network connection, including but not limited to, a local area network connection, a TCP/IP connection, a wireless connection, or any other means for operatively networking components together. Optionally, other data including graphics, sound files and other media data for use with the gaming terminal are stored in the same or a separate memory device (not shown). Some or all of the game program and its associated data may be loaded from one memory device into another, for example, from flash memory to random access memory (RAM).

In one or more embodiments, peripherals may be connected to the system over Ethernet connections directly to the appropriate server or tied to the system controller inside the gaming terminal using USB, serial or Ethernet connections. Each of the respective devices may have upgrades to their firmware utilizing these connections.

GMU 206 includes an integrated circuit board and GMU processor and memory including coding for network communications, such as the G2S (game-to-system) protocol from the Gaming Standards Association, Las Vegas, Nev., used for system communications over the network. As shown, GMU 206 may connect to the card reader 32 through bus 248 and may thereby obtain player information and transmit the information over the network through bus 236. Gaming activity information may be transferred by the EGM Processor Board 202 to GMU 206 where the information may be translated into a network protocol, such as S2S, for transmission to a server, such as a player tracking server, where information about a player's playing activity may be stored in a designated server database.

PID 208 includes an integrated circuit board, PID processor, and memory which includes an operating system, such as Windows CE, a player interface program which may be executable by the PID 208 processor together with various input/output (I/O) drivers for respective devices which connect to PID 208, such as player tracking module 28, and which may further include various games or game components playable on PID 208 or playable on a connected network server and PID 208 is operable as the player interface. PID 208 connects to card reader 36 through bus 218, player tracking display 30 through video decoder 250 and bus 216, such as an LVDS or VGA bus.

As part of its programming, the PID 208 processor executes coding to drive player tracking display 30 and provide messages and information to a player. Touch screen circuitry 252 interactively connects display 30 and video decoder 250 to PID 208 such that a player may input information and cause the information to be transmitted to PID 208 either on the player's initiative or responsive to a query by PID 208. Additionally soft keys 254 connect through bus 212 to PID 208 and operate together with the player tracking display 30 to provide information or queries to a player and receive responses or queries from the player. PID 208, in turn, communicates over the CMS/SMS network through Ethernet switch 226 and busses 230, 234 and with respective servers, such as a player tracking server.

PTMs 28 are linked into the virtual private network of the system components in gaming terminal 10. The system components include the player tacking module 28 (e.g. Bally iVIEW® device) (‘iView” is a registered trademark of Bally Gaming, Inc.) EGM Processing Board 202 and game monitoring unit (GMU) 206 processing board. These system components may connect over a network to the slot management system (such as a commercially available Bally SDS/SMS) and/or casino management system (such as a commercially available Bally CMP/CMS).

The GMU 206 system component has a connection to the base game through a serial SAS connection and is connected to various servers using, for example, HTTPs over Ethernet. Through this connection, firmware, media, operating system software, gaming machine configurations can be downloaded to the system components from the servers. This data is authenticated prior to installation on the system components.

The system components include the PTM 28 processing board and game monitoring unit (GMU) 206. The GMU 206 and PTM 28 can be combined into one like the commercially available Bally GTM iVIEW device. This device may have a video mixing technology to mix the EGM processor's video signals with the iVIEW display onto the top box monitor or any monitor on the gaming device.

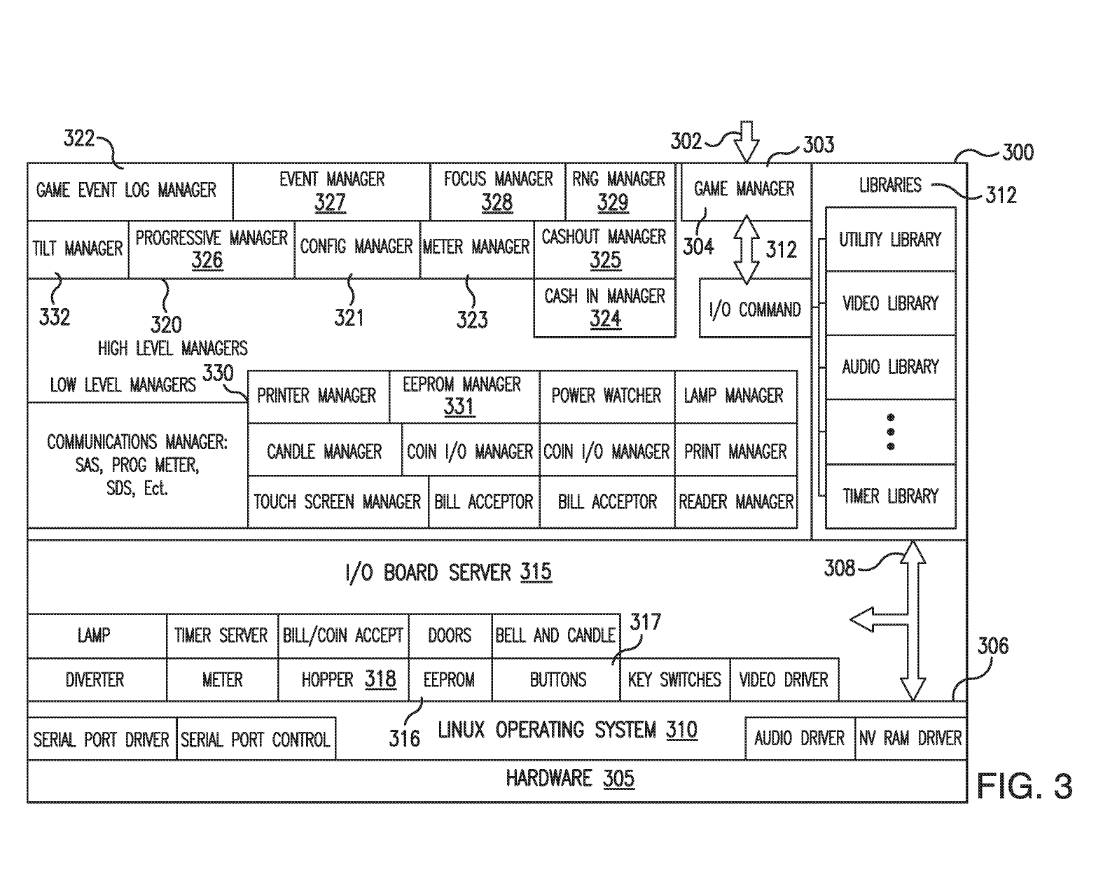

In accordance with one or more embodiments, FIG. 3 is a functional block diagram of a gaming kernel 300 of a game program under control of gaming EGM Processor board 202. The game program uses gaming kernel 300 by calling into application programming interface (API) 302, which is part of game manager 304. The components of game kernel 300 as shown in FIG. 3 are only illustrative, and should not be considered limiting. For example, the number of managers may be changed, additional managers may be added or some managers may be removed without deviating from the scope and spirit of the invention.

As shown in the example, there are three layers: a hardware layer 306; an operating system layer 308, such as, but not limited to, Linux; and a game kernel 300 layer having game manager 304 therein. In one or more embodiments, the use of an operating system layer 308, such a UNIX-based or Windows-based operating system, allows game developers interfacing to the gaming kernel to use any of a number of standard development tools and environments available for the operating systems. This is in contrast to the use of proprietary, low level interfaces which may require significant time and engineering investments for each game upgrade, hardware upgrade, or feature upgrade. The game kernel 300 layer executes at the user level of the operating system layer 308, and itself contains a major component called the I/O board server 315. To properly set the bounds of game application software (making integrity checking easier), all game applications interact with gaming kernel 300 using a single API 302 in game manager 304. This enables game applications to make use of a well-defined, consistent interface, as well as making access points to gaming kernel 300 controlled, where overall access is controlled using separate processes.

For example, game manager 304 parses an incoming command stream and, when a command dealing with I/O comes in (arrow 312), the command is sent to an applicable library routine 314. Library routine 314 decides what it needs from a device, and sends commands to I/O board server 315 (see arrow 316). A few specific drivers remain in operating system layer 308's kernel, shown as those below line 318. These are built-in, primitive, or privileged drivers that are (i) general (ii) kept to a minimum and (iii) are easier to leave than extract. In such cases, the low-level communications is handled within operating system layer 308 and the contents passed to library routines 314.

Thus, in a few cases library routines may interact with drivers inside operating system layer 308, which is why arrow 316 is shown as having three directions (between library routines 314 and I/O board server 315, or between library routines 314 and certain drivers in operating system layer 308). No matter which path is taken, the logic needed to work with each device is coded into modules in the user layer of the diagram. Operating system layer 310 is kept as simple, stripped down, and common across as many hardware platforms as possible. The library utilities and user-level drivers change as dictated by the game cabinet or game machine in which it will run. Thus, each game cabinet or game machine may have an industry standard EGM Processing Board 202 connected to a unique, relatively dumb, and as inexpensive as possible I/O adapter board, plus a gaming kernel 300 which will have the game-machine-unique library routines and I/O board server 315 components needed to enable game applications to interact with the gaming machine cabinet. Note that these differences are invisible to the game application software with the exception of certain functional differences (i.e., if a gaming cabinet has stereo sound, the game application will be able make use of API 302 to use the capability over that of a cabinet having traditional monaural sound).

Game manager 304 provides an interface into game kernel 300, providing consistent, predictable, and backwards compatible calling methods, syntax, and capabilities by way of game application API 302. This enables the game developer to be free of dealing directly with the hardware, including the freedom to not have to deal with low-level drivers as well as the freedom to not have to program lower level managers 330, although lower level managers 330 may be accessible through game manager 304's interface API 302 if a programmer has the need. In addition to the freedom derived from not having to deal with the hardware level drivers and the freedom of having consistent, callable, object-oriented interfaces to software managers of those components (drivers), game manager 304 provides access to a set of upper level managers 330 also having the advantages of consistent callable, object-oriented interfaces, and further providing the types and kinds of base functionality required in casino-type games. Game manager 304, providing all the advantages of its consistent and richly functional game application API 302 as supported by the rest of game kernel 300, thus provides a game developer with a multitude of advantages.

Game manager 304 may have several objects within itself, including an initialization object (not shown). The initialization object performs the initialization of the entire game machine, including other objects, after game manager 304 has started its internal objects and servers in appropriate order. In order to carry out this function, the kernel's configuration manager 322 is among the first objects to be started; configuration manager 322 has data needed to initialize and correctly configure other objects or servers.

The high level managers 320 of game kernel 300 may include game event log manager 326 which provides, at the least, a logging or logger base class, enabling other logging objects to be derived from this base object. The logger object is a generic logger; that is, it is not aware of the contents of logged messages and events. The game event log manager's 326 job is to log events in non-volatile event log space. The size of the space may be fixed, although the size of the logged event is typically not. When the event space or log space fills up, one embodiment will delete the oldest logged event (each logged event will have a time/date stamp, as well as other needed information such as length), providing space to record the new event. In this embodiment, the most recent events will thus be found in the log space, regardless of their relative importance. Further provided is the capability to read the stored logs for event review.

In accordance with one embodiment, meter manager 328 manages the various meters embodied in the game kernel 300. This includes the accounting information for the game machine and game play. There are hard meters (counters) and soft meters; the soft meters may be stored in non-volatile storage such as non-volatile battery-backed RAM to prevent loss. Further, a backup copy of the soft meters may be stored in a separate non-volatile storage such as EEPROM. In one embodiment, meter manager 328 receives its initialization data for the meters, during start-up, from configuration manager 322. While running, the cash in manager 330 and cash out manager 332 call the meter manager's 328 update functions to update the meters. Meter manager 328 will, on occasion, create backup copies of the soft meters by storing the soft meters' readings in EEPROM. This is accomplished by calling and using EEPROM manager 334.

In accordance with still other embodiments, progressive manager 336 manages progressive games playable from the game machine. Event manager 338 is generic, like game event log manager 326, and is used to manage various gaming machine events. Focus manager 340 correlates which process has control of various focus items. Tilt manager 342 is an object that receives a list of errors (if any) from configuration manager 322 at initialization, and during game play from processes, managers, drivers, etc. that may generate errors. Random number generator manager 329 is provided to allow easy programming access to a random number generator (RNG), as a RNG is required in virtually all casino-style (gambling) games. Random number generator manager 329 includes the capability of using multiple seeds.

In accordance with one or more embodiments, a credit manager object (not shown) manages the current state of credits (cash value or cash equivalent) in the game machine, including any available winnings, and further provides denomination conversion services. Cash out manager 332 has the responsibility of configuring and managing monetary output devices. During initialization, cash out manager 332, using data from configuration manager 322, sets the cash out devices correctly and selects any selectable cash out denominations. During play, a game application may post a cash out event through the event manager 338 (the same way all events are handled), and using a call back posted by cash out manager 332, cash out manager 332 is informed of the event. Cash out manager 332 updates the credit object, updates its state in non-volatile memory, and sends an appropriate control message to the device manager that corresponds to the dispensing device. As the device dispenses dispensable media, there will typically be event messages being sent back and forth between the device and cash out manager 332 until the dispensing finishes, after which cash out manager 332, having updated the credit manager and any other game state (such as some associated with meter manager 328) that needs to be updated for this set of actions, sends a cash out completion event to event manager 338 and to the game application thereby. Cash in manager 330 functions similarly to cash out manager 332, only controlling, interfacing with, and taking care of actions associated with cashing in events, cash in devices, and associated meters and crediting.

In a further example, in accordance with one or more embodiments, I/O board server 315 may write data to the gaming machine EEPROM memory, which is located in the gaming machine cabinet and holds meter storage that must be kept even in the event of power failure. Game manager 304 calls the I/O library functions to write data to the EEPROM. The I/O board server 315 receives the request and starts a low priority EEPROM thread 344 within I/O board server 315 to write the data. This thread uses a sequence of 8 bit command and data writes to the EEPROM device to write the appropriate data in the proper location within the device. Any errors detected will be sent as IPC messages to game manager 304. All of this processing is asynchronous.

In accordance with one embodiment, button module 346 within I/O board server 315, polls (or is sent) the state of buttons every 2 ms. These inputs are debounced by keeping a history of input samples. Certain sequences of samples are required to detect a button was pressed, in which case the I/O board server 315 sends an inter-process communication event to game manager 304 that a button was pressed or released. In some embodiments, the gaming machine may have intelligent distributed I/O which debounces the buttons, in which case button module 346 may be able to communicate with the remote intelligent button processor to get the button events and simply relay them to game manager 304 via IPC messages. In still another embodiment, the I/O library may be used for pay out requests from the game application. For example, hopper module 348 must start the hopper motor, constantly monitor the coin sensing lines of the hopper, debounce them, and send an IPC message to the game manager 304 when each coin is paid.

Further details, including disclosure of lower level fault handling and/or processing, are included in U.S. Pat. No. 7,351,151 issued Apr. 1, 2008 entitled “Gaming Board Set and Gaming Kernel for Game Cabinets” the disclosure of which is incorporated herein by explicit reference.

Referring to FIGS. 4A and B, an example of a host gaming system 801 is shown in accordance with one or more embodiments. Gaming system 801 may include one casino or multiple locations and generally includes a network of gaming terminals 803 (such as a gaming terminals 10 of the type as described in FIG. 1), floor management system (SMS) 805, and casino management system (CMS) 807. SMS 805 may include load balancer 811, network services server 813, player tracking module 28, iView (PTM 28) content servers 815, certificate services server 817, floor radio dispatch receiver/transmitters (RDC) 819, floor transaction servers 821 and game engines 823 (where the gaming terminals 803 operate server based or downloadable games), each of which may connect over network bus 825 to gaming terminals 803. CMS 807 may include location tracking server 831, WRG RTCEM server 833, data warehouse 835, player tracking server 837, biometric server 839, analysis services server 841, third party interface server 843, slot accounting server 845, floor accounting server 847, progressives server 849, promo control server 851, bonus game (such as Bally Live Rewards) server 853, download control server 855, player history database 857, configuration management server 859, browser manager 861, tournament engine server 863 connecting through bus 865 to server host 867 and gaming terminals 803. The various servers and gaming terminals 803 may connect to the network with various conventional network connections (such as, for example, USB, serial, parallel, RS485, Ethernet). Additional servers which may be incorporated with CMS 807 include a responsible gaming limit server (not shown), advertisement server (not shown), and a control station server (not shown) where an operator or authorized personnel may select options and input new programming to adjust each of the respective servers and gaming terminals 803. SMS 805 may also have additional servers including a control station (not shown) through which authorized personnel may select options, modify programming, and obtain reports of the connected servers and devices, and obtain reports. The various CMS and SMS servers are descriptively entitled to reflect the functional executable programming stored thereon and the nature of databases maintained and utilized in performing their respective functions.

The gaming terminals 803 include various peripheral components that may be connected with USB, serial, parallel, RS-485 or Ethernet devices/architectures to the system components within the respective gaming machine. The GMU 507 has a connection to the base game through a serial SAS connection. The system components in the gaming cabinet may be connected to the servers using HTTPs or G2S over Ethernet. Using CMS 807 and/or SMS 805 servers and devices, firmware, media, operating systems, and configurations may be downloaded to the system components of respective gaming devices for upgrading or managing floor content and offerings in accordance with operator selections or automatically depending upon CMS 807 and SMS 805 master programming. The data and programming updates to gaming terminals 803 are authenticated using conventional techniques prior to install on the system components.

In various embodiments, any of the gaming terminals 803 may be a mechanical reel spinning slot machine, video slot machine, video poker machine, video bingo machine, keno machine, or a gaming device offering one or more of the above described games including an interactive wheel feature. Alternately, gaming terminals 803 may provide a game with an accumulation-style feature game as one of a set of multiple primary games selected for play by a random number generator, as described above. A gaming system 801 of the type described above also allows a plurality of games in accordance with the various embodiments of the invention to be linked under the control of a group game server (not shown) for cooperative or competitive play in a particular area, carousel, casino or between casinos located in geographically separate areas. For example, one or more examples of group games under control of a group game server are disclosed in U.S. Published Application 2008/0139305, entitled “Networked System and Method for Group Gaming,” filed on Nov. 9, 2007, which is hereby incorporated by reference in its entirety for all purposes.

The gaming system 801, among other functionalities such as slot accounting (i.e. monitoring the amount wagered (“drop”), awards paid) and other casino services, includes the player tracking CMS/CMP server 837 and/or data warehouse 835 storing player account data. This data includes personal data for players enrolled in the casino players club sometimes referred to as a loyalty club. An example of the personal data is the player's name, address, SSN, birth date, spouse's name and perhaps personal preferences such as types of games, preferences regarding promotions and the like. As is known in the industry and according to the prior art, at enrolment the player is assigned a created account in the player tracking CMS/CMP server 837 and is issued a player tracking card having a machine readable magnetic stripe.

When a player plays a gaming terminal 10, he/she inserts their player tracking card into the card reader 32 (FIG. 1) which communicates data to the CMS/CMP server 837 to accumulate loyalty points based upon the wagers/wins of the player. For example, a player may accumulate one loyalty point for each $5 wagered.

The system 801 may also include electronic transfer of funds functionality. For example, a player having accumulated $100 at a gaming terminal 10 may decide to “cash out” to play another gaming terminal. The player, for example using the PTM 28 to initiate communication with the system 801 for example server 837 to upload the value from the gaming terminal 803 into an electronic account associated with the player's account. The player may choose to upload all or a portion of the funds the player's established electronic account. The system would prompt the player to enter their PIN (or obtain biometrical confirmation as to the player's identity) and upload the chosen amount to their account. When the player moves to another gaming terminal 10 he/she inserts their player loyalty card into the card reader 32 to access their account. A prompt provides for the player to request funds from their account. Entering their PIN (or biometric identifier) the player can input the desired amount which is downloaded to their gaming terminal 10 for play.

At a casino enterprise a player/user may have an established player account. That account may include data such as the player's personal information such as name and address, available credit level, their casino rating and their available comps. At the casino enterprise the player may use accrued comps to purchase goods and services or to obtain other benefits. Further the casino enterprise may wish to provide content including interactive content by the way promotions, bonus games, advertising, vouchers and the like to the players from the system. When the player is at a gaming terminal 10 and identified to the casino host system as by, for example, having their player card read by the card reader, the host system thereby identifies the player and can fashion and deliver the content to the PTM display 30 or at a display area defined, for example, at the primary display 14. However if the player leaves the gaming terminal 10 they no longer has access to the system provided interactive content. It would be advantageous if a system and method were provided which could maintain a seamless connectivity with a player through their mobile device to continue to provide content and to derive data for the purposes of business intelligence concerning the player.

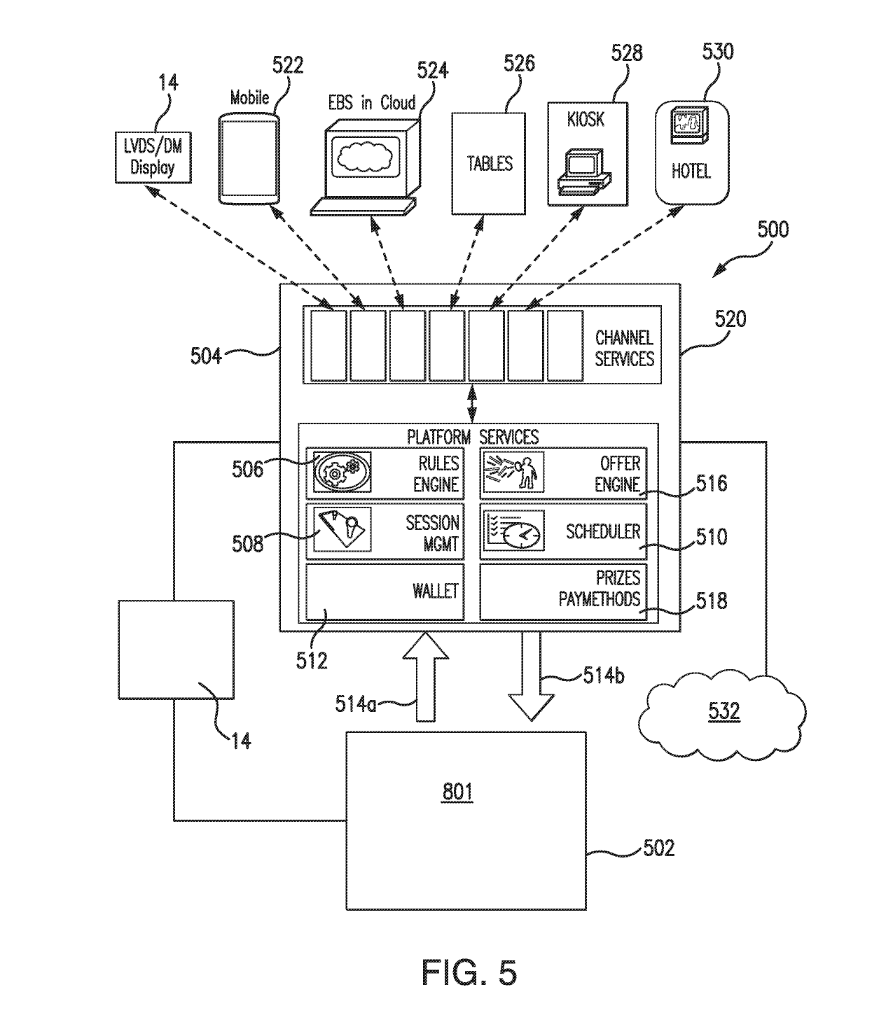

Turning to FIG. 5 there is shown a diagram of a system architecture for providing seamless communication of content including interactive content to a player and for supporting business analytics related to the player's interactions according to an embodiment of the present invention. The system 500 embraces host system 502 which includes the gaming system 801 described above as well a seamless channel services delivery module 504 of the type hereinafter described. The host system 502 also includes servers configured to operate, for example, casino signage, system bonusing systems and other services and features for the host enterprise. The host system 502 is in communication with the delivery module 504. The delivery module 504 is configured to have a rules engine 506 which is configured to establish and enforce operational rules as described herein. A session management module 508 manages system interactive content delivery sessions and interfaces with a scheduling module 510. Also included is an eWallet manager 512 which may establish and configure a player's electronic wallet alone or in combination with server 837 of the gaming system 801 as indicted by bi-directional data/process arrows 514a, b. An offer engine 516 is provided to configure promotional and other offers for the players such as interactive promotions and other advertising or promotions. A prize pay method module 518 provides for configuration of methods for issuing awards to the players such as by vouchers, coupons, play of additional or free games, goods or services.

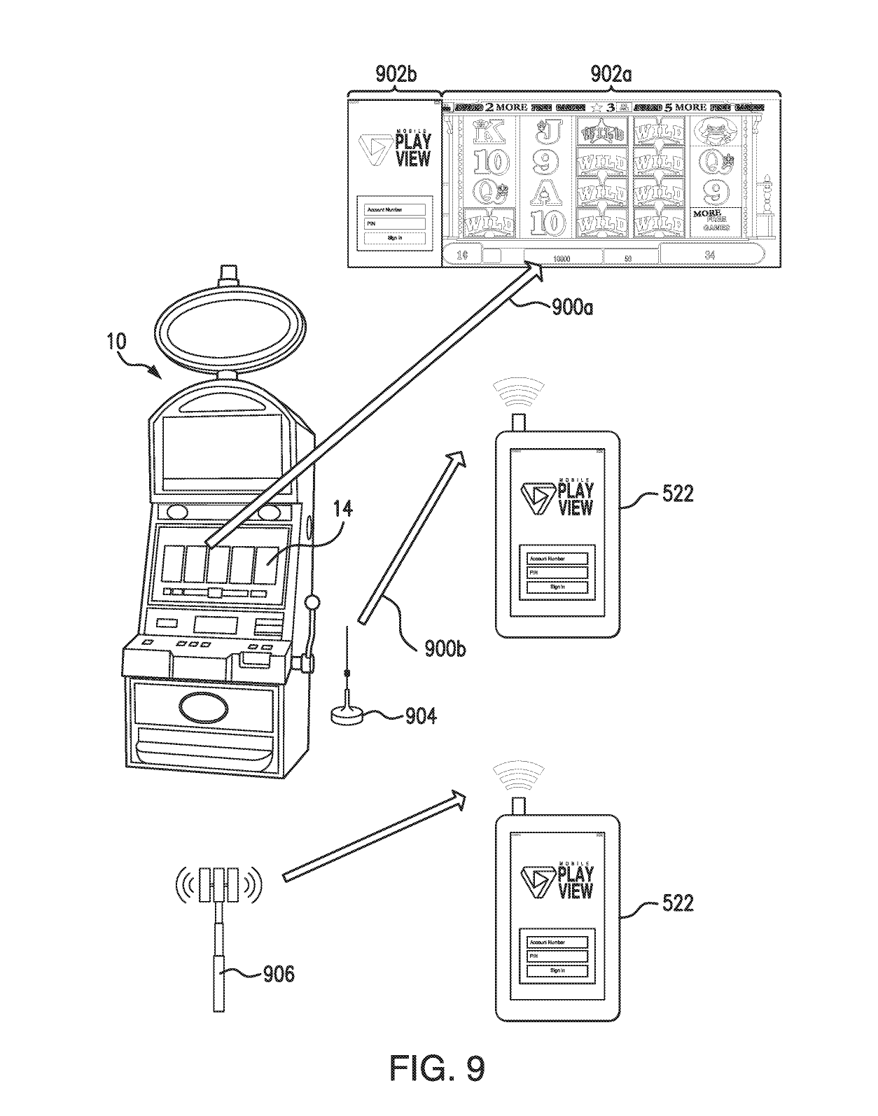

The system 50 has a channel services module 520 which provides for various channels of bi-directional, interactive or non-interactive communication to the player. For example, the system 500 may provide the content to the player at the terminal primary display 14 (also shown as the LVDS/DM display) at the gaming terminal 10 through a hard-wired, CATV 5 network system channel at the casino. The content can also be provided to the PTM display 30 (FIG. 1). One or more channels may also provide the content to a player's mobile device 522. With reference to FIG. 9 communication with the mobile device 522 via at least two channels is shown. For example, as stated above, the system 500 is configured to deliver content to the PTM display 30 or the gaming terminal primary display 14 at a dedicated area or window. For example arrow 900a (FIG. 9) illustrates an example of a display of game content 902a and system content 902b defined at the primary display 14. The system content 902b is located in a picture-in-picture window defined at the primary display 14. In the fashion according to the prior art the player may interact with the system content 902b by accessing their player account, accepting offers or promotions, playing secondary games making restaurant or hotel reservations or the like.

Associated with the gaming terminal 10 is a wireless beacon-transceiver 904 which is connected to the host system 500 as by being connected to hard-wired casino network. The transceiver 904 provides for short-range, wireless, bi-directional communication with the player's mobile device such as through a BLE Bluetooth® or other wireless near field communication network. When the player's mobile device 522 comes into range of the transceiver 904, a short range communication channel is enabled as shown by arrow 900b. At this point the player may be prompted at either the gaming terminal 10 or their mobile device 522 to engage in the binding of the mobile device 522 to the network 500. The binding may be accomplished by the player acquiring an image of a displayed bar or QR code or glyph at the gaming terminal 10 or biometric identification such as capturing an image of the player's face, capturing a finger print or image of the player's iris or other biometric sampling. This binding may require the player to input a personal identification number (PIN) as well. Binding may also be accomplished by near field communication such as the player tapping or holding their mobile device 522 at a designated location on the gaming terminal 10. In another embodiment the binding may be facilitated by the player prompting their mobile device 522 to display a code (bar code, QR code, glyph or other image) to be read by an optical reader/scanner on the gaming terminal 10. Augmented reality could also be used to bind the mobile device 522 by the layer acquiring an image of the gaming terminal 10 and surroundings for optical analysis and comparison to locate the player and bind their device, When bound at least the system content is then enabled to be concurrently delivered to the gaming terminal 10 PTM display 30 or a window at the gaming terminal 10 primary display 14 and, via the short range wireless channel, the player's mobile device 522. The player may opt to concurrently view the system delivered content 902b at one or both of the primary display 14 and at their mobile device 522 or can elect to close one of the views, for example, the view of the content 902b at the primary display 14.

The communication channel services module 520 also has a mobile cellular communication channel. With reference to FIG. 9, when the player's mobile device is outside of the range of the short range communication channel, the interactive content is delivered via mobile cellular communication networks such as 2G, 3GPP and 4G networks as suggested by cellular tower 906 and arrow 1008. When the player moves out of the short range field the delivery of content is handled over to the mobile cellular communication channel in a seamless manner such that to the player the system content is delivered in an uninterrupted fashion. Conversely when the player goes to another gaming terminal 10, communication with the mobile device 522 is handled overt to the short range channel.

Returning to FIG. 5, the communication channel services module 520 also is in communication with an electronic bonusing system (EBS) 524 which may be hosted in a cloud environment. This channel of communications provides for the introduction of system bonusing techniques such as bonus games, bonusing qualification criteria, and with one or more of the rules engine 506, offer engine 516 and scheduling manager 510 provides bonusing for the players. Also in communication with the channel services module are one or more hybrid, live or electronic tables 526 inasmuch as such devices include card readers for reading player loyalty cards and may include interactive displays. Communication with these devices within the casino would be through the wired network. One or interactive kiosks 528 are also in communication with the channel services module 520 whereby, via the wired network, interactive system content may be displayed thereat. For example a player may call up account information at a kiosk, accept promotions or view other content. At 530 the hotel operations system may also be connected to the channel services module 520 to provide benefits to a player, such as a discount or upgrade, and to track the player's stays and hotel related activities for purposes of business intelligence.

To provide access for running business intelligence software or for importing third party content or for running special software applications, the host system 500 is connected to one or more internal or external business intelligence resources 532 such as third party hosted BI software as well as third party applications such as message broking software (e.g. Apache Kafka, The Apache Software Foundation, Dept. 9660, Los Angeles, Calif. 90084-9660 U.S.A.), database management software (Apache Cassandra), distributed computing and machine learning software (e.g. MLlib by Apache Spark).

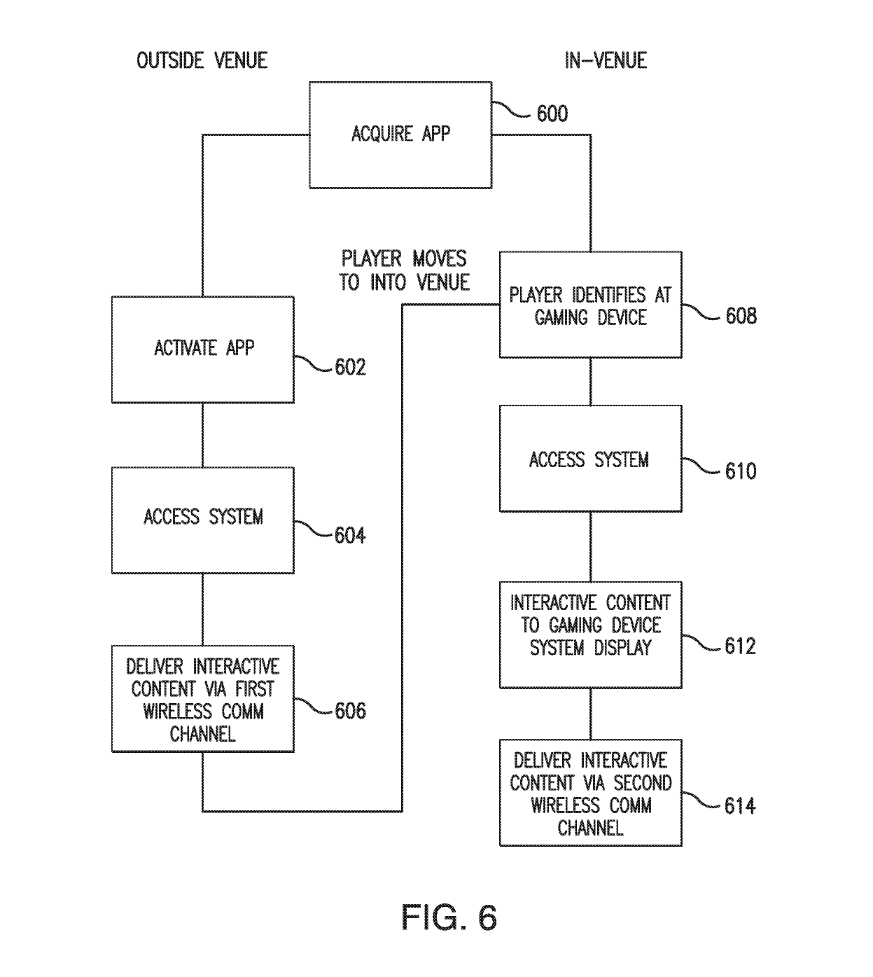

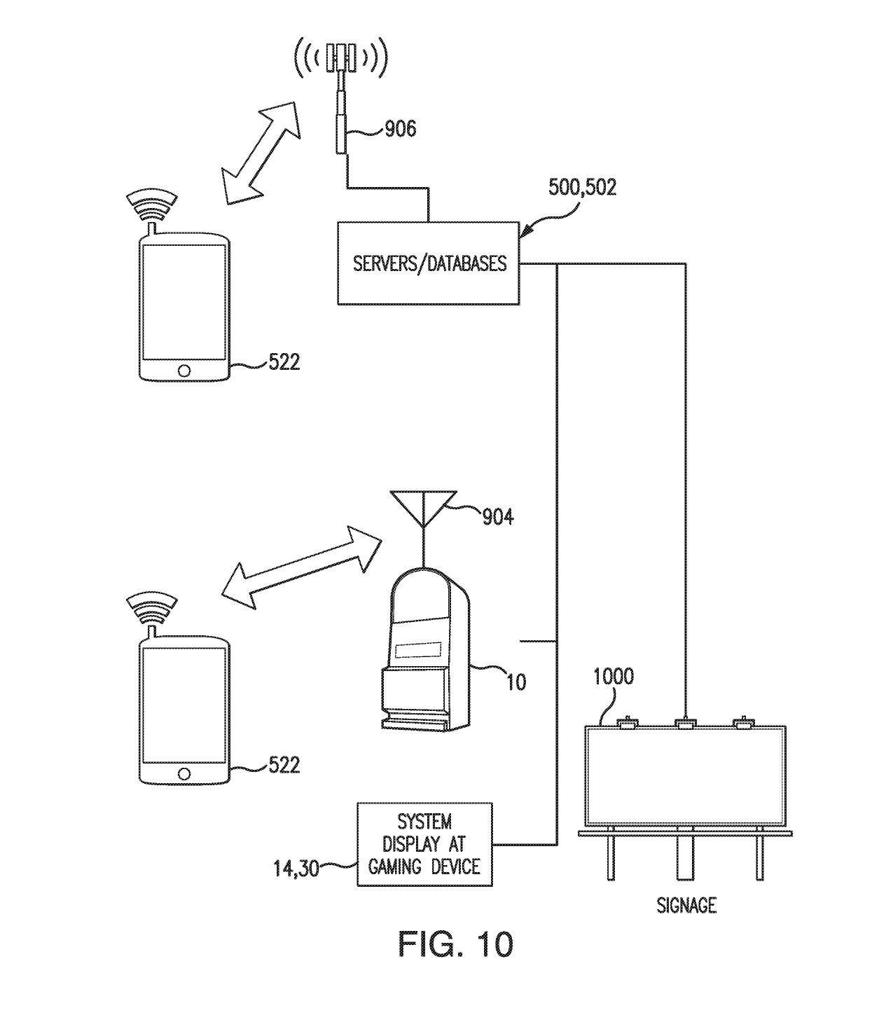

FIG. 6 is a logic diagram illustrating the handing over of communication channels as described with reference to FIG. 10. At 600 the player acquires a host services application by downloading the same to their mobile device 522 from the host casino website at their leisure or when the player registers at the player loyalty club. This application configures the player's mobile device 522 to receive and display interactive content, in the aspect ratio compatible with the display of the mobile device, and may also provide for the player to set up various features such as social media sharing, an eWallet and a player access PIN. When the player is outside of the casino or otherwise outside of the range of a casino enabled short range wireless beacon-transceiver, such as by being in a casino restaurant or shop, and the player activates the application at 602, the system interactive content is accessed at 604 and may be delivered, e.g. pushed and or accessed by the player's mobile device 522 via a first communication channel such as the mobile cellular channel at 606. The player's account information as well as interactive content such as games and promotions is delivered to the player's mobile device 522 and using the mobile device input interface the player may interact such as by accepting offers or providing controlling input for games or other features or viewing different pages of interactive content.

When the player moves inside the casino venue and for example at 608 identifies at a gaming terminal 10 the player's device 522 recognizes that it is in the range of a beacon-transceiver 904 and at 610 hands over communication to the short-range, wireless second communication channel at 610. At 612 the system interactive content may be concurrently delivered to the gaming terminal 10 primary display 14 as well as at 614 to the player's mobile device 522. Thus the delivery of the interactive system content is virtually seamless to the player's mobile device 522. Moving into and out of the wireless, short range, second communication channel the communication is handed off to the mobile cellular first communication channel and visa-versa.

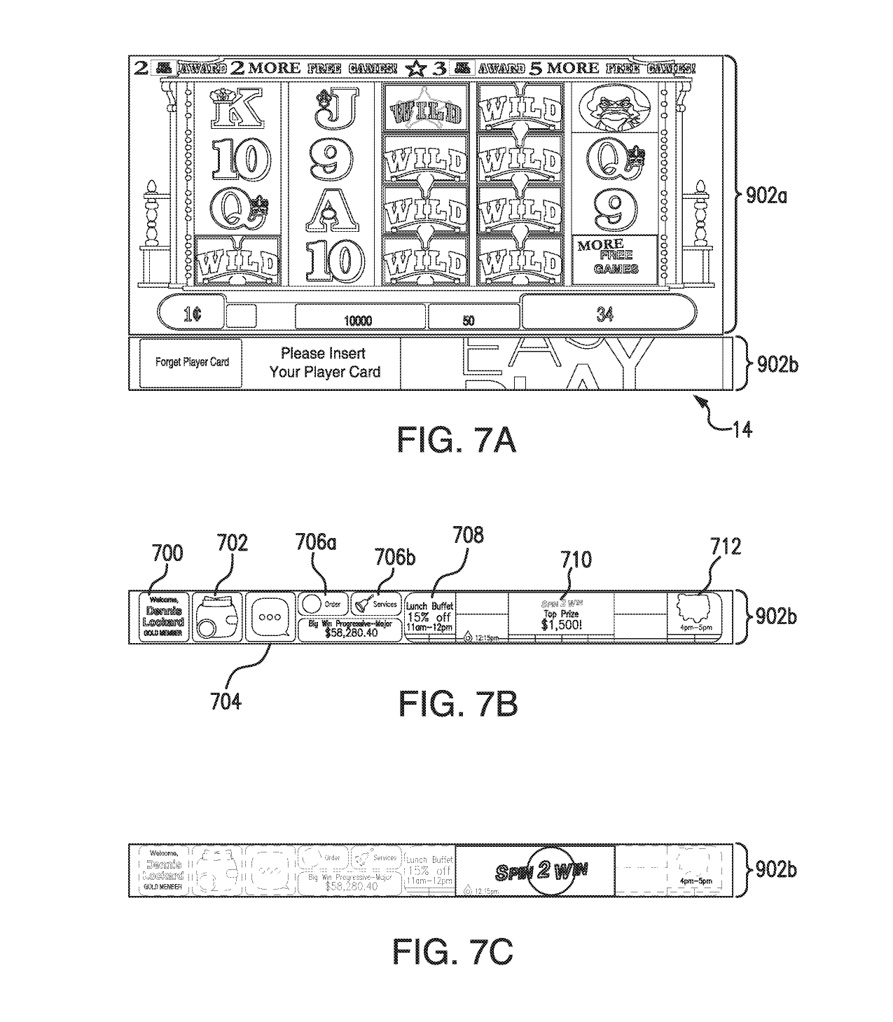

FIGS. 7A-7B illustrate a view of the primary display 14 showing the game content 902a and system derived interactive content 902b displayed in an area or window below the game content 902a. The system content 902b may be messages, promotions, games and the like. FIG. 7B shows different system content 902b including icons to at 700 show that the system has identified the player, an eWallet icon 702 which if selected by the player will provide access to the player's electronic wallet, a chat icon 704 to enable the player to engage is chat services with other players, service request icons 706a,b to request a beverage or other services, a promotional offer icon 708, an offer icon 710 to enable the player to play a promotional game and perhaps a tournament offer icon 712 to enable the player to enroll in a tournament. Some of the offers or promotions may require the player to meet qualification criteria. The system content 902b may be displayed as a window defined above or the side of the game content 902a.

FIG. 7C shows an example of the player having selected to play the promotions game.

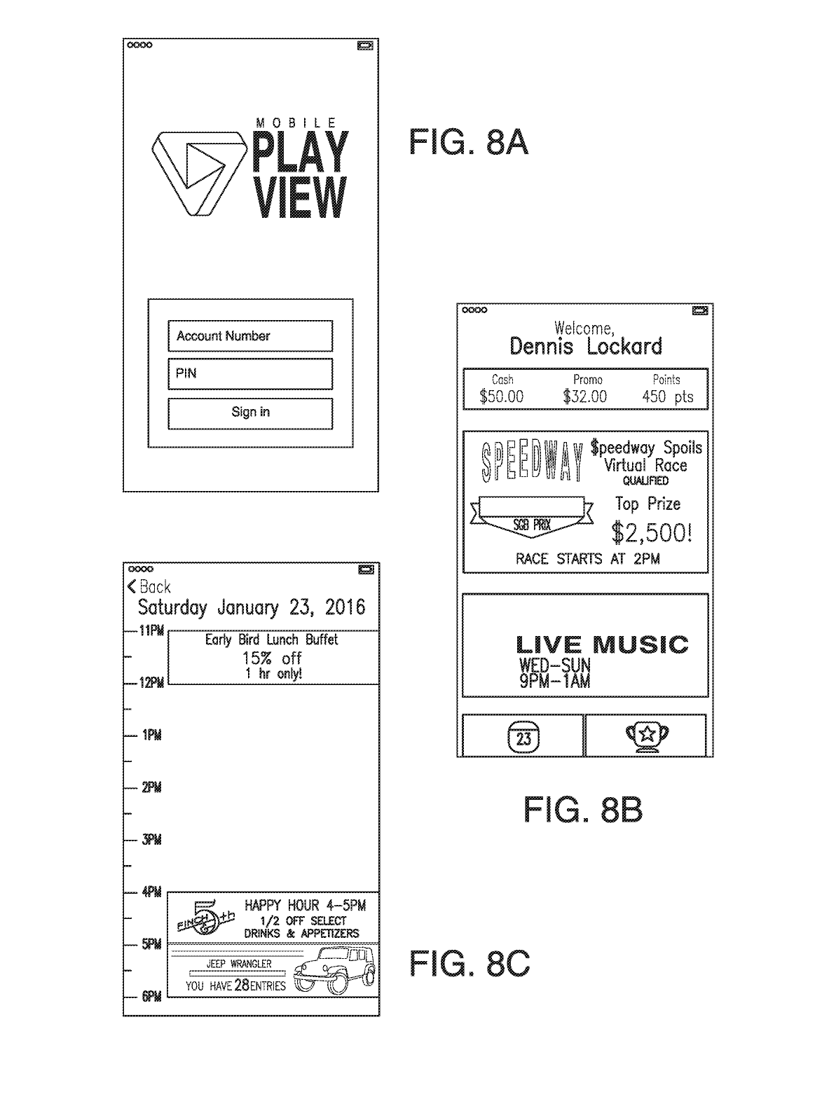

FIGS. 8A-8C show examples of the system content which may be provided to the player's mobile device 522 display. At 8A the player has accessed the application and is invited to log in using their account number and PIN. At 8B the player has accessed their account and is provided with advertising, promotions and player account information. If the player were identified at a gaming terminal 10 and so desired this information would be concurrently displayed at, for example, the PTM display 40 or in a window at the primary display 14. FIG. 8C shows an interactive calendar showing the scheduling of events and promotions for the venue and the player.

FIG. 10 illustrates the system for delivery of content via multiple communication channels to a user's mobile device 522 as well as to the gaming terminal 10 and signage 1000. As described above with reference to FIG. 5, the host system 500 including the channel services module 520 delivers through the first communication channel cellular tower 906 the interactive content to the player's mobile device 522. The player may view the content at the mobile device 522 display as well provide interactive input through the mobile device interface such as keypad or touch screen. When the player enters the range of the wireless short range second channel as by sitting at a gaming terminal 10 and identifying at the terminal with, for example their player card and/or binding their mobile device 522 to the network system 500 as described above, the system 500 turns over communication with the mobile device 522 to the second communication channel to maintain a seamless communication with the player's mobile device 522. Concurrently the system 500 may deliver system content to the system display at the gaming terminal such as the PTM display 30 or at the primary display 14. The system 500 may also deliver system content to electronic signage 1000 perhaps in the area of the player. Inasmuch as the player's geo-location can be determined by the known location of the beacon transceiver 904 and/or the gaming terminal 10 where the player has logged in, the system 500 can send system content to the signage 1000 to augment the player's experience.

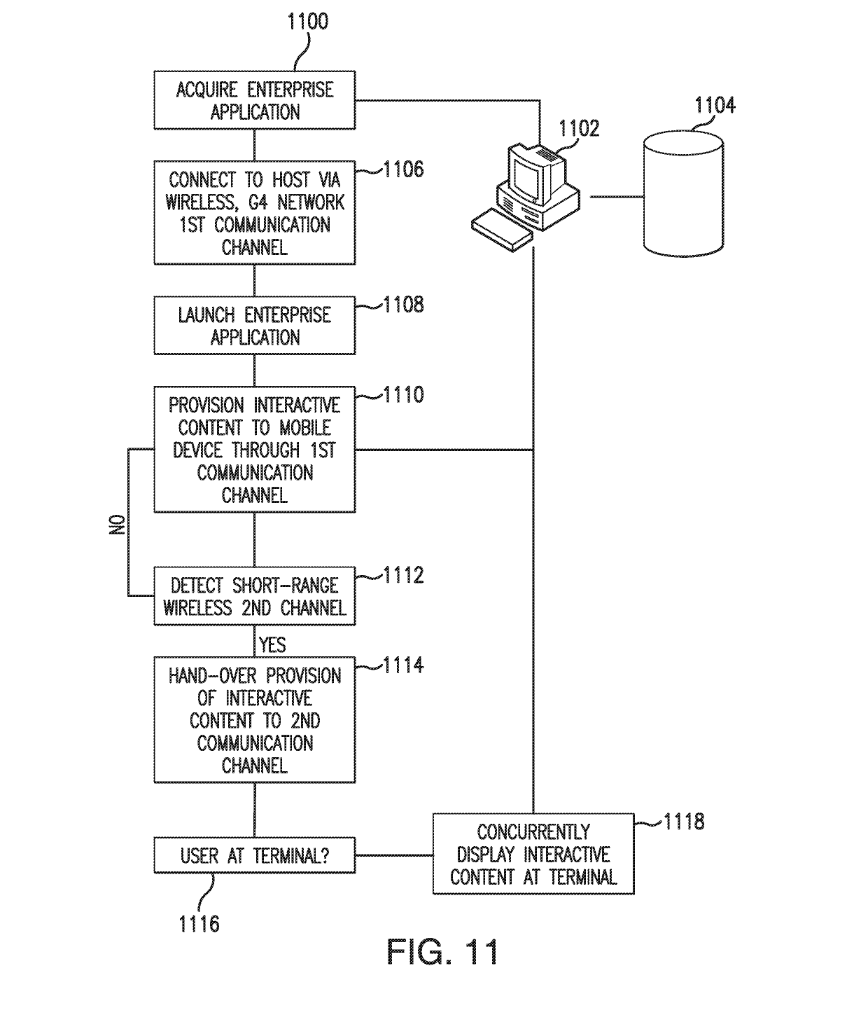

FIG. 11 is a logic diagram for a mobile device software application according to various embodiments of the present invention. At 1100 the player acquires the enterprise mobile device application. The acquisition may be done remotely through the enterprise's web site, social media or it may be acquired when the player registers at the enterprise loyalty club such as at a service center 1102 and a data repository 1104. At 1106 the player connects to the host system via the mobile cellular first communication channel and at 1108 launches the enterprise application. When the player has been authorized at 1110 the interactive content is sent to the mobile device 522 through the first communication channel. If there is no detection of a compatible short range channel at 1112, the content continues to be provided thought the first communication channel. However, if at 1112 the mobile device application detects the wireless, short range second communication channel is available and the player binds to the system 500, at 1114 communication of the content to the player's mobile device is available to be handed off to the second communication channel. At 1116 if the player is also detected at a gaming terminal 10, at 1118 the system interactive content may be concurrently provided to the system display(s) at the gaming terminal 10.

The enterprise application, using one or both of the communication channels may track the geo-location of the mobile device 522. When using the mobile cellular first communication channel the mobile device geo-positioning may be used, e.g. cellular tower triangulation, and when the player is receiving by the second communication channel through the known locations of the beacon transceivers 904 and gaming terminals 10. The movements of the player may be useful in configuring content as well as for business intelligence. Further the player's interaction with the system may also provide business intelligence such as favorite games, wagering amounts (derived from the player tracking system), the types and nature of promotions or coupons favored by the player and the like.

While the above description is directed to a casino enterprise it should be understood that the systems and methods described herein can be used with other enterprises such as mercantile establishments where the terminals are point of sale terminals or user kiosks.

The system 500 may also alter or provide additional content to the player's mobile device 522 based upon the communication channel being used by the mobile device 522. For example, if the player is communication via the mobile cellular, first, communication channel, the content may be less casino-centric to provide the player with other services and promotions to entice the player to return to the casino. When the player mobile device 522 is utilizing the second communication channel the content may be more gaming-centric offering free play, new games, progressive jackpot information and the like.

The foregoing description, for purposes of explanation, uses specific nomenclature and formula to provide a thorough understanding of the invention. It should be apparent to those of skill in the art that the specific details are not required in order to practice the invention. The embodiments have been chosen and described to best explain the principles of the invention and its practical application, thereby enabling others of skill in the art to utilize the invention, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

What is claimed is:

1. An improved system for providing for seamless user interactive content to a user's mobile device and at a user terminal including (i) one or more data servers and data repositories to package and transmit interactive content via a wireless mobile telephone bi-directional first communication channel for wire-less telephonic communication with the user mobile device, the user mobile device having a display and a user input interface and the terminal including a terminal video display and in bi-directional network communication with the one or more servers to display interactive content at the terminal display, an improved system comprising:
a software application to configure the user's mobile device for establishing the first communication channel link with the one or more servers to receive and display the interactive content at the mobile device display and to transmit user inputs from the user interface to the one or more servers;
a short range communication beacon-transceiver associated with the terminal, the geo-location of the beacon-transmitter and associated terminal being known;
the software application configuring the user's mobile device to establish a bi-directional short-range second channel communication link between the user's mobile device and the one or more servers when the user's mobile device is within a short range of a beacon-transceiver, the second channel communication with the user's mobile device defining a geo-location for the user's device proximate the terminal;
configuring the one or more servers to provide the interactive content;
the one or more servers and user's mobile device configured by the software application to (a) when the user's mobile device is within the short range, concurrently provide the interactive content to the terminal display via the network and the user's mobile device display through the second channel and to receive user inputs from one or the user interface and a terminal user interface and (b) when the user's mobile device is outside of the short range to hand-off the provision of the interactive content to the user's mobile device over the first communication channel.

2. A system comprising:
an external host system configured to deliver system content;
a fixed gaming terminal configured to communicate with the host system via a network communication channel, the gaming terminal including a video display, the gaming terminal configured to receive the system content via the network communication channel and display the delivered system content on the video display; and
a software application configuring a user's mobile device to communicate with the host system via a first wireless communication channel when the mobile device is remote from the gaming terminal and via a second, different wireless communication channel when the mobile device is proximate the gaming terminal, the software application configuring the mobile device to receive the system content via the first or second communication channel depending upon whether the mobile device is remote from or proximate the gaming terminal and to display the delivered system content.

3. The system of claim 2, wherein the system content includes interactive content, the gaming terminal configured to receive user inputs and transmit the user inputs to the host system via the network communication channel, the software application configuring the mobile device to receive other user inputs and transmit the other user inputs to the host system via the first or second communication channel depending upon whether the mobile device is remote from or proximate the gaming terminal.

4. The system of claim 2, wherein the system content includes one or more of advertising, promotions, notifications, account information, transactions, games, surveys, or community activities.

5. The system of claim 2, wherein the system content includes first content and second content, the software application configuring the mobile device to receive the first content, but not the second content, via the first communication channel and to receive the second content, but not the first content, via the second communication channel.

6. The system of claim 2, wherein the first communication channel is a mobile cellular network, and wherein the second communication channel is a short-range channel.

7. The system of claim 6, further including a beacon-transceiver associated with the gaming terminal and coupled to the host system via the network communication channel, the software application configuring the mobile device to establish the short-range channel with the beacon-transceiver when the mobile device is within a short range of the beacon-transceiver, the mobile device communicating with the host system via the short-range channel between the mobile device and the beacon-transceiver and the network communication channel between the beacon-transceiver and the host system.

8. The system of claim 2, wherein when the mobile device is proximate the gaming terminal, the host system is configured to concurrently deliver the system content to the gaming terminal and the mobile device.

9. The system of claim 2, wherein in response to the mobile device moving into and out of a range served by the second communication channel, delivery of the system content to the mobile device is handed off from the first communication channel to the second communication channel and vice versa.

10. The system of claim 2, further including a channel services module configured to serve the network communication channel, the first communication channel, and the second communication channel.

11. The system of claim 2, wherein the second communication channel defines a geo-location for the mobile device proximate the gaming terminal.

12. The system of claim 2, wherein the gaming terminal is configured to display the system content delivered thereto in a dedicated system window on the video display of the gaming terminal.

13. A method of operating a system including an external host system, a fixed gaming terminal, and a mobile device, the method comprising:
delivering system content from the host system to the gaming terminal for display thereon via a network communication channel; and
delivering the system content from the host system to the mobile device for display thereon via a first wireless communication channel when the mobile device is remote from the gaming terminal and via a second, different wireless communication channel when the mobile device is proximate the gaming terminal.

14. The method of claim 13, wherein the system content includes interactive content, and further comprising:
receiving user inputs at the gaming terminal and transmitting the user inputs from the gaming terminal to the host system via the network communication channel; and
receiving other user inputs at the mobile device and transmitting the other user inputs from the mobile device to the host system via the first communication channel when the mobile device is remote from the gaming terminal and via the second communication channel when the mobile device is proximate the gaming terminal.

15. The method of claim 13, wherein the system content includes one or more of advertising, promotions, notifications, account information, transactions, games, surveys, or community activities.

16. The method of claim 13, wherein the system content includes first content and second content, and further comprising delivering the first content, but not the second content, from the host system to the mobile device via the first communication channel and delivering the second content, but not the first content, from the host system to the mobile device via the second communication channel.

17. The method of claim 13, wherein the first communication channel is a mobile cellular network, and wherein the second communication channel is a short-range channel.

18. The method of claim 17, further including a beacon-transceiver associated with the gaming terminal and coupled to the host system via the network communication channel, and further comprising establishing the short-range channel with the beacon-transceiver when the mobile device is within a short range of the beacon-transceiver such that the system content is delivered from the host system to the mobile device via the network communication channel between the host system and the beacon-transceiver and via the short-range channel between the beacon-transceiver and the mobile device.

19. The method of claim 13, wherein when the mobile device is proximate the gaming terminal, the steps of delivering the system content from the host system to the gaming terminal and delivering the system content from the host system to the mobile device occur concurrently.

20. The method of claim 13, wherein in response to the mobile device moving into and out of a range served by the second communication channel, handing off delivery of the system content to the mobile device from the first communication channel to the second communication channel and vice versa.

21. The method of claim 13, further including a channel services module configured to serve the network communication channel, the first communication channel, and the second communication channel.

22. The method of claim 13, wherein the second communication channel defines a geo-location for the mobile device proximate the gaming terminal.

23. The method of claim 13, further comprising displaying the system content delivered to the gaming terminal in a dedicated system window on a video display of the gaming terminal.

24. A system comprising:
an external host system configured to deliver system content to a fixed gaming terminal for display thereon via a network communication channel; and
a software application configuring a user's mobile device to communicate with the host system via a first wireless communication channel when the mobile device is remote from the gaming terminal and via a second, different wireless communication channel when the mobile device is proximate the gaming terminal, the software application configuring the mobile device to receive the system content via the first or second communication channel depending upon whether the mobile device is remote from or proximate the gaming terminal and to display the delivered system content.

25. The system of claim 24, wherein the first communication channel is a mobile cellular network, and wherein the second communication channel is a short-range channel.

26. The system of claim 25, further including a beacon-transceiver associated with the gaming terminal and coupled to the host system via the network communication channel, the software application configuring the mobile device to establish the short-range channel with the beacon-transceiver when the mobile device is within a short range of the beacon-transceiver, the mobile device communicating with the host system via the short-range channel between the mobile device and the beacon-transceiver and the network communication channel between the beacon-transceiver and the host system.

27. The system of claim 24, wherein when the mobile device is proximate the gaming terminal, the host system is configured to concurrently deliver the system content to the gaming terminal and the mobile device.

28. The system of claim 24, wherein in response to the mobile device moving into and out of a range served by the second communication channel, delivery of the system content to the mobile device is handed off from the first communication channel to the second communication channel and vice versa.
